(19) United States
(12) Patent Application Publication
(10) Pub. No.: US 2012/0162047 A1
(43) Pub. Date: Jun. 28, 2012

(54) FLEXIBLE PRINTED WIRING BOARD AND WIRELESS COMMUNICATION MODULE

(75) Inventors: Hironobu MIZUNO, Saitama (JP); Yoshihiro HATTORI, Saitama (JP)

(73) Assignee: CANON COMPONENTS, INC., Kodama-gun (JP)

(21) Appl. No.: 13/336,461

(22) Filed: Dec. 23, 2011

(30) Foreign Application Priority Data
Dec. 27, 2010 (JP) 2010-290962
Dec. 15, 2011 (JP) 2011-274673

(51) Int. Cl. H01Q 1/38

(52) U.S. Cl. 343/905

(57) ABSTRACT

There is provided a wireless communication module structured by integrally united forming on a film-like flexible board, a transmitting-receiving antenna section for transmitting and receiving RF signals (high frequency signals), a transmission line section for transmitting the RF signals, and a high frequency circuit section, wherein the film-like flexible board has a plurality of seamless conductor layers formed thereon, and dielectric constants of insulating layers formed between a plurality of the seamless conductor layers or in the vicinity thereof are different between in an area of the transmitting-receiving antenna section and in an area of the transmission line section and the high frequency circuit section.

### CROSS-REFERENCE TO RELATED APPLICATIONS

This application is based upon and claims the benefit of priority of the prior Japanese Patent Application Nos. 2010-290962, filed on Dec. 27, 2010 and 2011-274673, filed on Dec. 15, 2011, the entire contents of which are incorporated herein by reference.

### BACKGROUND OF THE INVENTION

1. Field of the Invention

The present invention relates particularly to a flexible printed wiring board and a wireless communication module usable in wireless communication apparatuses.

2. Description of the Related Art

In recent years, wireless communication modules for use in wireless communication apparatuses, such as mobile apparatuses including cellular phones, digital cameras and printers, are required to be smaller and thinner. The demands for flexible modules are also growing from the viewpoint of lower costs and higher degree of freedom of design in a casing.

FIG. 22 is a view explaining an example of a basic structure of a conventional wireless communication module 31. As shown in FIG. 22, the wireless communication module 31 is generally composed of a transmitting-receiving antenna section 32 and a high frequency circuit section 34 which are each fabricated on a printed circuit board and are connected to each other through coaxial connectors 35 via a transmission line section 33 made of a coaxial cable. Electric power is fed from an electrode 36 to the high frequency circuit section 34 via an I/O line 37 and a connector 39, by which control and data signals are inputted and outputted.

In the past, the antenna section was mainly made of a rigid printed circuit board, and the transmission line section was structured mainly with use of a coaxial cable. As a consequence, wireless communication modules were large as a whole, and so the modules were difficult to place in a narrow space of small-size communication apparatuses and were also expensive. In order to solve such problems, various proposals have been made. For example, Patent Document 1 discloses a module having a surface mounted antenna directly mounted on a printed board. Integrally mounting components on one board in this example makes it possible to stabilize impedance and to downsize wireless communication modules. Employed as a film sensor described in the Patent Document 1 is a film-like board having flexibility in an antenna section.

As another technology for downsizing wireless communication modules, a strip line cable structured by integrating an antenna section and a transmission line section is disclosed in Patent Document 2. As a technology to enhance reliability of wireless communication modules, an antenna system without a connection section between an antenna and a high frequency circuit is disclosed in Patent Document 3. Patent Document 4 discloses a technology of a three-layer structure in which insulators having an antenna conductor have different dielectric constants for the purpose of achieving smaller and thinner antenna system.
Patent Document 1 Japanese Laid-open Patent Publication No. 2002-111346
Patent Document 2 Japanese Laid-open Patent Publication No. 08-242117
Patent Document 3 Japanese Laid-open Patent Publication No. 11-214916
Patent Document 4 Japanese Laid-open Patent Publication No. 2004-135044

However, in the film sensor disclosed in Patent Document 1 and the strip line cable having the integrated antenna section and transmission line section disclosed in Patent Document 2, a high frequency circuit for allowing the antenna section to perform reception and transmission is provided as a separate body. This causes problems of insufficient reliability in connection and high costs as connectors need to be placed for establishing connection. Further in the strip line cable disclosed in Patent Document 2, since the antenna section is composed of an insulating layer and a central conductor which extend from a transmission line section, it is difficult to design dielectrics, which are structured respectively as an antenna section and as a transmission line section, to have dielectric constants corresponding to respective functions and high frequency signals. Moreover, in an antenna system without connection section, which is disclosed in Patent Document 3, a circuit section is made of materials with a high dielectric constant to decrease radiation loss of electromagnetic waves, however, in a viewpoint of achieving downsizing, thinning and flexibility, the antenna system is insufficient and therefore is not good enough to be applied to communication apparatuses which require downsizing and weight saving. Further, the antenna system disclosed in Patent Document 4 has insufficient flexibility and insufficient reliability in connection.

### SUMMARY OF THE INVENTION

In view of the above-mentioned problems, an object of the present invention is to provide a flexible printed wiring board and a wireless communication module which ensure reliability in communication and which are smaller, thinner and flexible.

A flexible printed wiring board according to the present invention includes: a transmitting-receiving antenna section transmitting and receiving a high frequency signal; a transmission line section transmitting the high frequency signal; and a high frequency circuit section generating the high frequency signal and feeding the high frequency signal to an electronic component, the transmitting-receiving antenna section, the transmission line section and the high frequency circuit section being integrally united formed on an insulation film, the insulation film having a conductor layer formed on one side or both sides thereof, the conductor layer continuing through the transmitting-receiving antenna section, the transmission line section and the high frequency circuit section, the insulation film further having insulating layers formed thereon, the insulating layers having dielectric constants different between in an area of the transmitting-receiving antenna section and in an area of the transmission line section and the high frequency circuit section.

A flexible printed wiring board in another aspect of the present invention includes: a transmitting-receiving antenna section transmitting and receiving a high frequency signal; a transmission line section transmitting the high frequency signal; and a high frequency circuit section generating the high frequency signal and feeding the high frequency signal to an electronic component, the transmitting-receiving antenna section, the transmission line section and the high frequency circuit section being integrally united formed on an insulation film, the insulation film having a conductor layer formed on one side or both sides thereof, the conductor layer continuing through the transmitting-receiving antenna section, the transmission line section and the high frequency circuit section, the insulation film further having an insulating layer formed in at least one area among an area of the transmitting-receiving antenna section, an area of the transmission line section and an area of the high frequency circuit section, the insulating layer having a dielectric constant different from those of other areas.

A wireless communication module according to the present invention includes the flexible printed wiring board and an electronic component.

### BRIEF DESCRIPTION OF THE DRAWINGS

FIG. 1 is a view showing an example of a schematic structure of a wireless communication module according to embodiments of the present invention;

FIG. 2 is a view showing an example of a cross section of a flexible board in a first embodiment of the present invention viewed from a longitudinal direction;

FIG. 3 is a view showing an example of a cross section of a transmission line section in a film-like flexible board in the first embodiment of the present invention;

FIG. 4 is a view showing another example of a cross section of a transmission line section in a film-like flexible board in the first embodiment of the present invention;

FIG. 5 is a cross sectional view showing a structure example of a wireless communication module having an electronic component mounted on a high frequency circuit section in a film-like flexible board in the first embodiment of the present invention;

FIG. 6 is a cross sectional view showing another structure example of a wireless communication module having an electronic component mounted on a high frequency circuit section in a film-like flexible board in the first embodiment of the present invention;

FIG. 7 is a view showing an example of a cross section of a film-like flexible board in a second embodiment of the present invention viewed from the longitudinal direction;

FIG. 8 is a view showing another example of a cross section of the film-like flexible board in the second embodiment of the present invention viewed from the longitudinal direction;

FIG. 9 is a view showing an example of a cross section of a film-like flexible board in a third embodiment of the present invention viewed from the longitudinal direction;

FIG. 10 is a view showing an example of a cross section of a transmission line section in a film-like flexible board in the third embodiment of the present invention;

FIG. 11 is a view showing another example of a cross section of a transmission line section in a film-like flexible board in the third embodiment of the present invention;

FIG. 12 is a view showing an example of a cross section of a film-like flexible board in a fourth embodiment of the present invention viewed from the longitudinal direction;

FIG. 13 is a view showing another example of a cross section of a film-like flexible board in the fourth embodiment of the present invention viewed from the longitudinal direction;

FIG. 14 is a view showing an example of a cross section of a film-like flexible board in a fifth embodiment of the present invention viewed from the longitudinal direction;

FIG. 15 is a view showing an example of a cross section of a transmission line section in a film-like flexible board in the fifth embodiment of the present invention;

FIG. 16 is a view showing another example of a cross section of a transmission line section in a film-like flexible board in the fifth embodiment of the present invention;

FIG. 17 is a view showing an example of a cross section of a film-like flexible board in a sixth embodiment of the present invention viewed from the longitudinal direction;

FIG. 18 is a view showing another example of a cross section of a film-like flexible board in the sixth embodiment of the present invention viewed from the longitudinal direction;

FIG. 19 is a view showing another example of a cross section of a film-like flexible board in the sixth embodiment of the present invention viewed from the longitudinal direction;

FIG. 20 is a view explaining the position of a feeding point on a signal layer in the present invention;

FIG. 21 is a view showing an example of the concept in which a wireless communication module with use of the flexible board of the present invention is built into a control instrument;

FIG. 22 is a view showing an example of a basic structure of a conventional wireless communication module; and

FIG. 23 is a view showing an example of a cross section of a film-like flexible board in a seventh embodiment of the present invention viewed from the longitudinal direction.

### DETAILED DESCRIPTION OF THE PREFERRED EMBODIMENTS

Hereinafter, a description will be given of some structures relating to conductor layers and insulating layers of flexible printed wiring boards (hereinafter abbreviated as flexible boards) for use in a wireless module of the present invention. A description will also be given of a wireless communication module of the present invention with electronic components necessary for these flexible boards mounted thereon.

A wireless module of the present invention includes a flexible board including a transmitting-receiving antenna section for transmitting and receiving high frequency signal to and from an external device, a high frequency circuit section for generating the high frequency signals and feeding the high frequency signals to electronic components, and a transmission line section for transmitting the high frequency signals between the high frequency circuit section and the transmitting-receiving antenna section, the respective sections being integrally united formed on one side or both sides of one base film that is a flexible film made of an insulator. In later-described embodiments, the flexible film that is one base film is referred to as a first insulating layer. The following description discusses a flexible board on which at least one insulating layer is each placed at an area of the transmitting-receiving antenna section and an area extending from the transmission line section to the high frequency circuit section in the first insulating layer, the insulating layers having different dielectric constants so that the dielectric constants in two areas are controlled. In the present invention, the first to fourth insulating layers described below are made of dielectric materials and the concept thereof refers to film-like insulators or dielectrics which not only insulate between conductor layers but also cover the upper and lower sides of the conductor layers to insulate and protect from the outside.

Further, at least one conductor layer is continuously formed on the flexible board according to the present invention so that the conductor layer extends from the transmitting-receiving antenna section to the high frequency circuit section through the transmission line section without any joint portion. In short, the conductor layer is formed seamlessly. Such seamless conductor layers may be formed by an identical process, and thin film layers made of materials such as metals that can establish easy electrical conduction in a continuous state may be used. In the case where a plurality of conductor layers are provided, these layers form a multilayered structure.

### First Embodiment

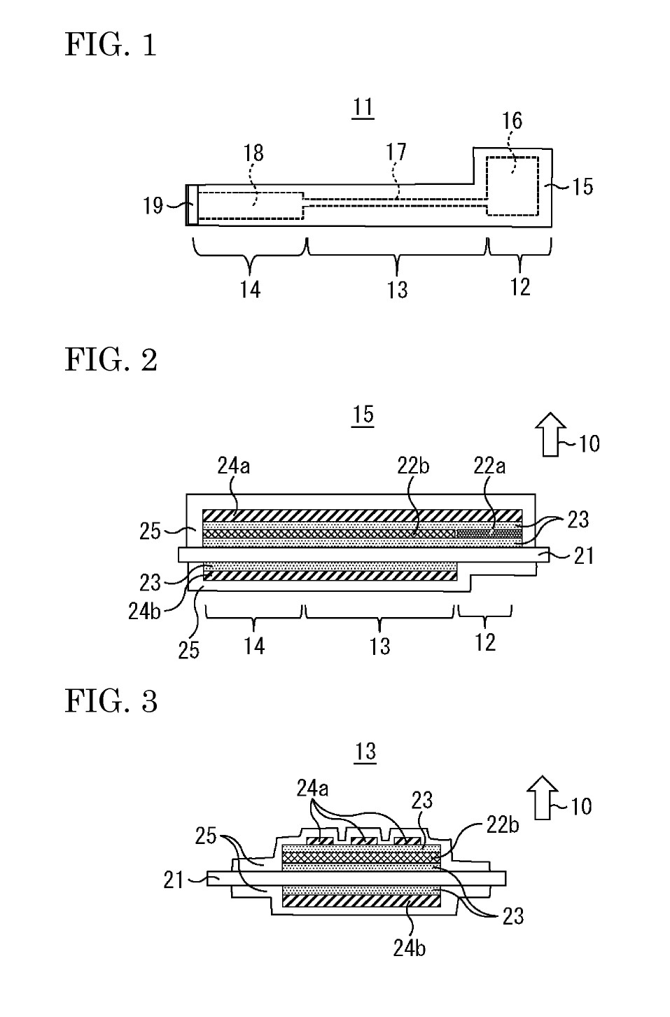

A first embodiment of the present invention will be described hereinbelow with reference to FIG. 1 to FIG. 5.

FIG. 1 is a view showing an example of a schematic structure of a wireless communication module 11 according to the present embodiment.

As shown in FIG. 1, formed on a film-like flexible board 15 having flexibility are units including a transmitting-receiving antenna section 12 for transmitting and receiving high frequency signal, a transmission line section 13 for transmitting the high frequency signals, and a high frequency circuit section 14. The flexible board 15 is connected to an external connection electrode 19, and a conductor layer is formed continuously thereon. The conductor layer includes a conductor layer of transmitting-receiving antenna section 16, a conductor layer of transmission section 17, and a conductor layer of high frequency circuit section 18.

FIG. 2 is a cross sectional view parallel in a longitudinal direction showing an example of a film-like flexible board 15 according to the present embodiment. Hereinafter in an explanation of each drawing, the direction of an arrow 10 in drawings is referred to as an upper side, while a reverse direction of the arrow 10 is referred to as a lower side.

As shown in FIG. 2, the flexible board 15 forms a dielectric including insulating layers whose dielectric constants are different between in an area of the transmitting-receiving antenna section 12 and in an area extending from the transmission line section 13 to the high frequency circuit section 14. On the upper side of a first insulating layer 21 that is a base film for the flexible board 15, a second insulating layer 22a is formed in the transmitting-receiving antenna section 12 sandwiching a third insulating layer 23 that is an adhesive layer, while a second insulating layer 22b is formed in the area extending from the transmission line section 13 to the high frequency circuit section 14. In this case, the second insulating layers 22a, 22b are made of materials whose dielectric constants are different from each other.

On the upper side of the second insulating layers 22a, 22b, a signal layer 24a is formed sandwiching a third insulating layer 23 that is an adhesive layer so as to extend seamlessly from the transmitting-receiving antenna section 12 to the high frequency circuit section 14 through the transmission line section 13. Further on the upper side of the signal layer 24a, a fourth insulating layer 25 is formed as a protective layer so as to cover the second insulating layers 22a, 22b, the third insulating layer 23 and the signal layer 24a. The signal layer 24a that is a conductor layer of the present embodiment is formed seamlessly as a signal interconnection extending from the transmitting-receiving antenna section 12 to the high frequency circuit section 14 through the transmission line section 13. Accordingly, high frequency characteristics and reliability in connection are enhanced.

On the lower side of the first insulating layer 21, a ground layer 24b is formed sandwiching a third insulating layer 23 that is an adhesive layer in the area extending from the transmission line section 13 to the high frequency circuit section 14. Thus, the ground layer 24b is seamlessly formed as a conductor layer continuing over the area extending from the transmission line section 13 to the high frequency circuit section 14. It is not necessary to provide an adhesive layer under the first insulating layer 21 at the area of the transmitting-receiving antenna section 12.

Further, a fourth insulating layer 25 is formed so as to cover the lower surface of the first insulating layer 21 at the transmitting-receiving antenna section 12 and the lower surface of the ground layer 24b. If the fourth insulating layer that functions as a protective layer is placed mainly for the purpose of preventing exposure of the conductor layer, then the fourth insulating layer 25 may be structured so that the lower surface of the first insulating layer 21 is opened without being covered.

A description is now given of each layer shown in FIG. 2.

In FIG. 2, an area of the signal layer 24a at the transmitting-receiving antenna section 12, which is corresponding to the conductor layer of the transmitting-receiving antenna section 16, is formed in a direction orthogonal to the page as a flat-shaped antenna pattern such as publicly known inverted F antennas, L-shaped antennas, meander antennas, and folded dipole antennas.

An area of the signal layer 24a at the transmission line section 13, which is corresponding to the conductor layer of transmission line section 17, has a conductor pattern dimensioned to optimize matching of impedance in transmission and reception of high frequency signals depending on the materials of the first insulating layer 21, the second insulating layers 22a, 22b, the third insulating layer 23, and the fourth insulating layer 25. In the transmission line section 13, the conductor pattern of the signal layer 24a may partially be widened to form a capacitor with the ground layer 24b for impedance matching. Impedance adjustment elements such as L (coil) and C (capacitor) may be placed where necessary.

The signal layer 24a and the ground layer 24b may be formed with materials such as copper foils or metal interconnections. In the case of using copper foils, a film bonded to copper foils with use of an adhesive layer and the like may be used, and photolitho etching process may be applied thereto to form a required electrode pattern. In the case of forming metal interconnections by ink jet drawing, a required pattern may be drawn on a film by an ink jet method with use of polymer ink containing metallic particles, and the film may be calcined at the temperature equal to or below a glass transition point (Tg) of the film to burn out the polymer ink, so that the metal interconnection pattern can be formed. The thickness of the metal interconnections formed by ink jet drawing may be selected in the range of about 0.05 μm to 5 μm.

The first insulating layer 21 and the second insulating layers 22a, 22b are formed by using films or sheets made of organic materials as shown below. In the case of using materials with a relatively high relative dielectric constant value of 3 to 5, materials such as polyimides, nylons, polyethylene terephthalate, epoxy resins, glass epoxies and micas are used for example. In the case of using lower dielectric constant materials with a relative dielectric constant of less than 3, materials such as liquid crystal polymers and cycloolefin polymers are used for example. In the case of using high dielectric constant materials with a relative dielectric constant of more than 5, publicly known polymeric materials such as ferroelectric polymers and organic semiconductor dielectric layers are used. The thickness of the first insulating layer 21 and the second insulating layers 22a, 22b made of such materials are made to be several μm to hundreds of μm.

In the present embodiment, a boundary between the second insulating layer 22a formed in the transmitting-receiving antenna section 12 and the second insulating layer 22b formed over from the transmission line section 13 to the high frequency circuit section 14 is determined by a feeding point on the signal layer 24a. The feeding point is herein defined as a junction between the transmitting-receiving antenna section and a feed line of the transmission line section for feeding and receiving high-frequency power to and from the transmitting-receiving antenna section 12 which emits high-frequency power to a space as electromagnetic waves and which receives electromagnetic waves in a space as high-frequency power. As shown in FIG. 20, the feeding point 20 is merely an indicator indicating a point on the signal layer 24a, and the signal layer 24a itself is a seamless conductor layer.

The third insulating layer 23 that is an adhesive layer is formed with publicly known adhesives such as acrylic adhesives, epoxy adhesives, and silicone adhesives. To apply adhesives, such methods as a method of bonding a sheet-like adhesive layer to a target layer and a method of applying liquid adhesives with a dispenser or by printing and hardening the adhesives by heat or ultraviolet irradiation may be used. In FIG. 2, the adhesive layer for bonding the first insulating layer 21 to the second insulating layers 22a, 22b and the adhesive layer for bonding the second insulating layers 22a, 22b to the signal layer 24a or the ground layer 24b that is a conductor layer are denoted by the same reference sign for simplified explanation. In forming these adhesive layers, different materials and different processes may be employed, and the film thickness of each adhesive layer may be different. Since it is advantageous that the third insulating layer 23 is less influential as a dielectric in consideration of the degree of freedom in thickness design of other insulating layers, the thickness thereof is set at several-tenths of μm to several tens of μm.

The fourth insulating layer 25 may be made of the same materials as those of the first insulating layer 21 or the second insulating layers 22a, 22b. The same materials as those of the adhesives used as the third insulating layer 23 may also be used. Further, protective materials such as solder resists for use in manufacturing a printed wiring board may be used. In the example shown in FIG. 2, the fourth insulating layer 25 is made of solder resist materials, which makes an adhesive layer unnecessary. When the fourth insulating layer 25 is made of film-like materials such as polyimides and nylons, an adhesive layer is necessary.

In FIG. 2, setting of a dielectric constant of the dielectric constituted of the first insulating layer 21 to the fourth insulating layer 25 (the second insulating layers 22a, 22b in particular) is different depending on design of the wireless communication module.

For example, the following materials are used when design is made with a priority given to downsizing the transmitting-receiving antenna section 12. The second insulating layer 22a of the transmitting-receiving antenna section 12 is made of the aforementioned materials with a high dielectric constant, while the second insulating layer 22b of the transmission line section 13 and the high frequency circuit section 14 is made of materials with a low dielectric constant to suppress dielectric loss and delay.

The following materials are used when design is made with a priority given to enhancing radiation efficiency of electromagnetic waves from the transmitting-receiving antenna section 12. The aforementioned materials with a low dielectric constant are used for the second insulating layer 22a of the transmitting-receiving antenna section 12 to enhance the radiation efficiency to the upper space. The materials with a high dielectric constant are used for the second insulating layer 22b of the transmission line section 13 and the high frequency circuit section 14 to suppress radiation of excessive electromagnetic waves and electric waves.

As described above, materials with different dielectric constants are selected for the second insulating layers 22a, 22b depending on the purpose of design and other factors. This makes it possible to manufacture a flexible board 15 having laminated insulating layers whose dielectric constants are different between in the area of the transmitting-receiving antenna section 12 and in the area extending from the transmission line section 13 to the high frequency circuit section 14. To provide different dielectric constants to the second insulating layers 22a, 22b, a relative dielectric constant of 0.5 or more makes a significant difference in actuality.

Thus, in the flexible board 15 according to the present embodiment, a relative dielectric constant in the area of the transmitting-receiving antenna section 12 is different from that in the area extending from the transmission line section 13 to the high frequency circuit section 14. Measurement of relative dielectric constants may be performed by such methods as JIS-C6481.

FIG. 3 is a cross sectional view orthogonal to the longitudinal direction of the transmission line section 13 in the flexible board 15. In an example shown in FIG. 3, the transmission line section 13 has a so-called coplanar line structure. A signal layer 24a is formed from total three interconnections, which form a guard pattern with a central signal interconnection being interposed in between ground potentials on both sides. On the opposite side of the signal layer 24a, a ground layer 24b is formed across a second insulating layer 22b, a first insulating layer 21, and a third insulating layer 23. A fourth insulating layer 25 as a protective layer is formed to be in tight contact with the upper side of the signal layer 24a and the lower side of the ground layer 24b for covering these upper and lower side surfaces.

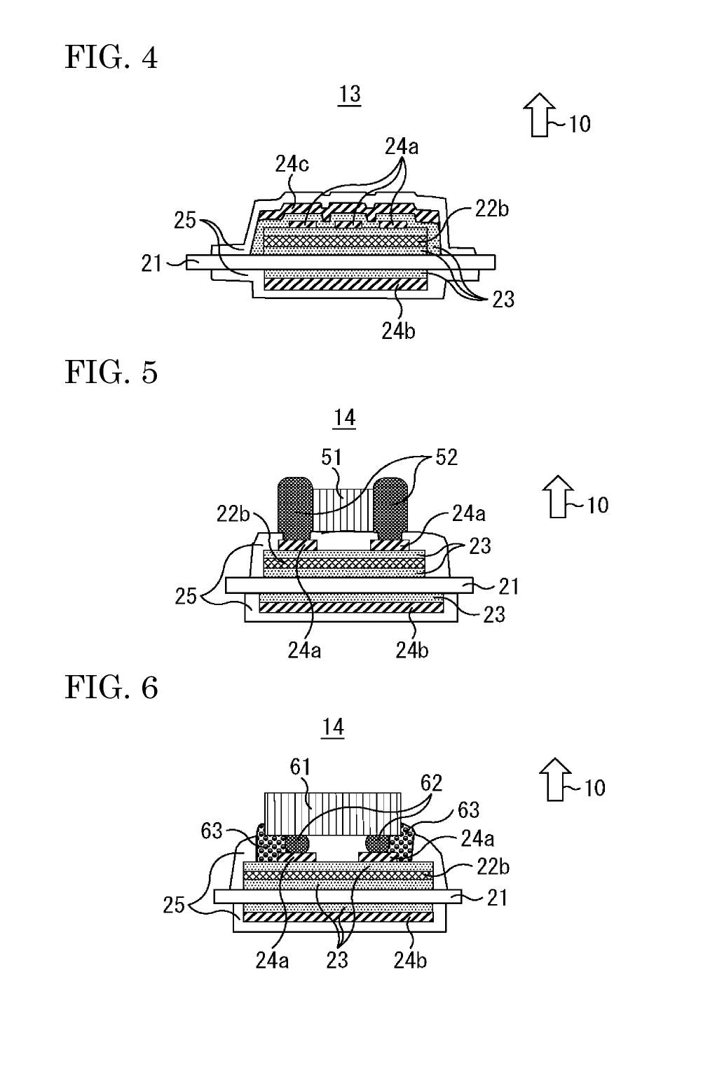

Instead of the coplanar line structure as shown in FIG. 3, a tri-plate structure as shown in FIG. 4 may be applied. FIG. 4 is a cross sectional view orthogonal to the longitudinal direction of the transmission line section 13 in the flexible board 15 showing the case where the tri-plate structure is applied. In an example shown in a FIG. 4, a third insulating layer 23 that is an adhesive layer is formed on the upper side of a signal layer 24a so as to cover a second insulating layer 22b and the signal layer 24a. Further on the upper side of the third insulating layer 23, a guard (shield) layer 24c is formed. As in the example shown in FIG. 3, a ground layer 24b is formed on the lower side of a first insulating layer 21. A fourth insulating layer 25 as a protective layer is formed to be in tight contact with the upper side of the guard (shield) layer 24c and the lower side of the ground layer 24b for covering these upper and lower side surfaces.

As shown in FIG. 3 or FIG. 4, the transmission line section 13 formed to have a coplanar line structure or a tri-plate structure enables the signal line to be less susceptible to an influence of external radiation noise and enables suppression of spurious emissions from the signal line itself. Selecting either the coplanar line structure or the tri-plate structure may suitably be made during arrangement design of communication apparatuses.

A description is now given of a structure of the high frequency circuit section 14 of the flexible board 15 in the present embodiment.

FIG. 5 is a cross sectional view orthogonal to the longitudinal direction showing an example of a high frequency circuit section 14 formed by mounting a chip-type passive electronic component 51 such as chip resistors, chip capacitors and chip coils on the flexible board 15. The example shown in FIG. 5 is an example of a wireless communication module 11 including a microstrip line having a coplanar line structure.

In procedures of fabricating the structure shown in FIG. 5, first a portion of the fourth insulating layer 25 where components are mounted is put into an opened state to expose a part of the signal layer 24a. Then, after a solder paste 52 is applied to the conductor surface by printing, a chip-type passive electronic component 51 is placed with a mounter, and reflow process is applied to obtain the structure in which the chip-type passive electronic component 51 is mounted on the flexible board 15.

In the case of the tri-plate structure with the guard (shield) layer 24c formed as shown in FIG. 4, the guard (shield) layer 24c and the third insulating layer 23 formed below the guard (shield) layer 24c are further put into an opened state to expose the signal layer 24a. This makes it possible to mount the chip-type passive electronic component 51 on the flexible board 15. Although FIG. 5 shows the case of using a chip component, ICs and LSIs for SMT may also be mounted on the flexible board 15 in a similar manner.

FIG. 6 is a cross sectional view orthogonal to the longitudinal direction showing an example of a high frequency circuit section 14 with a bear chip IC 61 mounted with use of a micro bump 62. In procedures of fabricating the structure shown in FIG. 6, first a portion of the fourth insulating layer 25 where a micro bump 62 is formed for mounting the bear chip IC 61 is put into an opened state as in FIG. 5. Then the bear chip IC 61 with the micro bump 62 attached thereto is placed and mounted on the flexible board 15 with solder by reflow. Then, an underfill 63 is applied by a dispensing method and is hardened through heat curing or UV curing so that the bear chip IC 61 is mounted on the flexible board 15.

Thus, the wireless communication module 11 can be fabricated by mounting required components as shown in the structure of FIG. 5 or FIG. 6 with use of the flexible board 15 according to the present embodiment.

As described above, at least either one of these conductor layers of the signal layer 24a and the ground layer 24b (as well as the guard (shield) layer 24c) formed as conductor layers on the film-like flexible board 15 in the present embodiment is a conductor layer extending over each unit including the transmitting-receiving antenna section 12, the transmission line section 13, and the high frequency circuit section 14, and at least one of these layers is formed seamlessly.

Therefore, the wireless communication module 11 of the present embodiment uses the flexible board 15 having conductor layers seamlessly formed in the transmitting-receiving antenna section 12 for transmitting and receiving RF signals, the transmission line section 13 for transmitting the RF signals (high frequency signals), and the high frequency circuit section 14. This makes it possible to achieve high reliability in connection and also to have smaller and thinner wireless communication modules. Since the flexible board 15 has flexibility, it becomes possible to freely place the wireless communication module 11 in communication apparatuses, so that small and highly reliable communication apparatuses can be obtained.

It is to be noted that the signal layer 24a and the ground layer 24b (as well as the guard (shield) layer 24c) that are conductor layers may be formed with use of the same material and the same process. They may also be formed with use of different materials and different processes. Further, each conductor layer may have a different film thickness, and these conductor layers may be formed by selecting copper foils or aluminum foils with a thickness of 5 μm to 50 μm.

### Second Embodiment

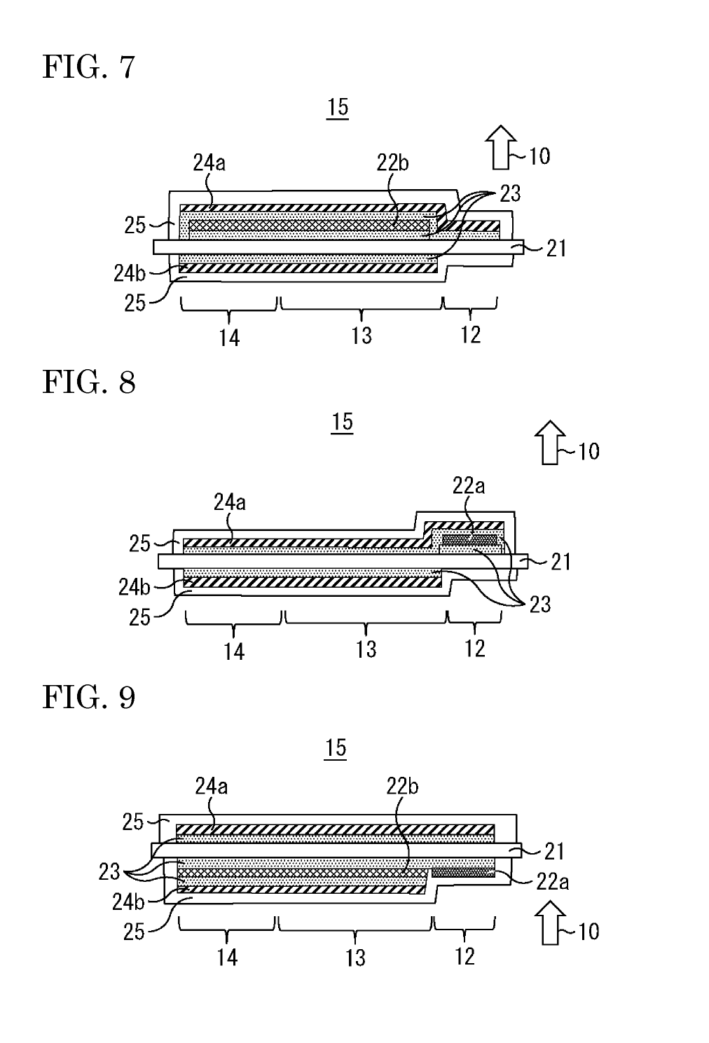

A second embodiment of the present invention will be described hereinbelow with reference to FIG. 7 and FIG. 8.

FIG. 7 and FIG. 8 are cross sectional views parallel in the longitudinal direction showing an example of a film-like flexible board 15 in the present embodiment.

As in the first embodiment, the flexible board 15 shown in FIG. 7 also forms a dielectric including insulating layers whose dielectric constants are different between in an area of the transmitting-receiving antenna section 12 and in an area extending from the transmission line section 13 to the high frequency circuit section 14. The flexible board 15 in the present embodiment is different from the structure in the first embodiment shown in FIG. 2 in the point that a second insulating layer 22a is not formed in the area of the transmitting-receiving antenna section 12. As in the first embodiment, a second insulating layer 22b is formed in the area extending from the transmission line section 13 to the high frequency circuit section 14. This second insulating layer 22b is made of materials with a dielectric constant relatively different from that of a first insulating layer 21 and a third insulating layer 23.

In the example shown in FIG. 7, the structure of the transmission line section 13 and the high frequency circuit section 14 as well as the materials of the conductor layers and the insulating layers are similar to those in the first embodiment. Further, as in the examples shown in FIG. 5 and FIG. 6, the wireless communication module 11 can be fabricated by mounting electronic components on the flexible board 15 shown in FIG. 7 with the same procedures as those in the first embodiment.

As in the first embodiment, the flexible board 15 in FIG. 8 also forms a dielectric including insulating layers whose dielectric constants are different between in an area of the transmitting-receiving antenna section 12 and in an area extending from the transmission line section 13 to the high frequency circuit section 14. The flexible board 15 in FIG. 8 is different from the structure in the first embodiment shown in FIG. 2 in the point that a second insulating layer 22b is not formed in the area extending from the transmission line section 13 to the high frequency circuit section 14. In the area of the transmitting-receiving antenna section 12, a second insulating layer 22a is formed as in the case of the first embodiment. The second insulating layer 22a is made of materials with a dielectric constant relatively different from that of a first insulating layer 21 and a third insulating layer 23.

The second insulating layer 22a shown in FIG. 7 and the second insulating layer 22b shown in FIG. 8 are made to have dielectric constants different from each other. The conductor layers and the electronic components to be mounted are similar to those in the first embodiment.

In the example shown in FIG. 8, the structure of the transmission line section 13 and the high frequency circuit section 14 is similar to that of the first embodiment except for the point that a second insulating layer 22b is not formed, while the materials of the conductor layers and the insulating layers are similar to those of the first embodiment. Further, as in the examples shown in FIG. 5 and FIG. 6, the wireless communication module 11 can be fabricated by mounting electronic components on the flexible board 15 shown in FIG. 8 with the same procedures as those in the first embodiment.

### Third Embodiment

A third embodiment of the present invention will be described hereinbelow with reference to FIG. 9 to FIG. 11.

FIG. 9 is a cross sectional view parallel in the longitudinal direction showing an example of a film-like flexible board 15 in the present embodiment.

As in the first embodiment, the flexible board 15 in FIG. 9 also forms a dielectric including insulating layers whose dielectric constants are different between in an area of the transmitting-receiving antenna section 12 and in an area extending from the transmission line section 13 to the high frequency circuit section 14. In the present embodiment, a third insulating layer 23 that is an adhesive layer is formed on the upper side of a first insulating layer 21, and further on the upper side of the third insulating layer 23, a signal layer 24a is seamlessly formed from the area of the transmitting-receiving antenna section 12 to the area of the transmission line section 13 and the high frequency circuit section 14. Thus, the signal layer 24a that is a conductor layer of the present embodiment is formed seamlessly as a signal interconnection extending from the transmitting-receiving antenna section 12 to the high frequency circuit section 14 through the transmission line section 13.

On the lower side of the first insulating layer 21, a third insulating layer 23 that is an adhesive layer is also formed. Further on the lower side of the third insulating layer 23, a second insulating layer 22b is formed in the area extending from the transmission line section 13 to the high frequency circuit section 14, and a second insulating layer 22a is formed in the area of the transmitting-receiving antenna section 12. The second insulating layers 22a, 22b are made of materials whose dielectric constants are different from each other.

Further, on the lower side of the second insulating layer 22b, a ground layer 24b is formed sandwiching the third insulating layer 23 in close contact therewith. Thus, the ground layer 24b is seamlessly formed as a conductor layer continuing over the area extending from the transmission line section 13 to the high frequency circuit section 14. Moreover, as shown in FIG. 9, a fourth insulating layer 25 is formed so as to continuously cover, as a protective layer, the upper side of the signal layer 24a, the lower side of the second insulating layer 22a and the lower side of the ground layer 24b. In the case where the main purpose of forming the fourth insulating layer 25 is to protect an exposed surface of the conductor layers, the fourth insulating layer 25 may be structured so that the lower side of the second insulating layer 22a is opened without being covered.

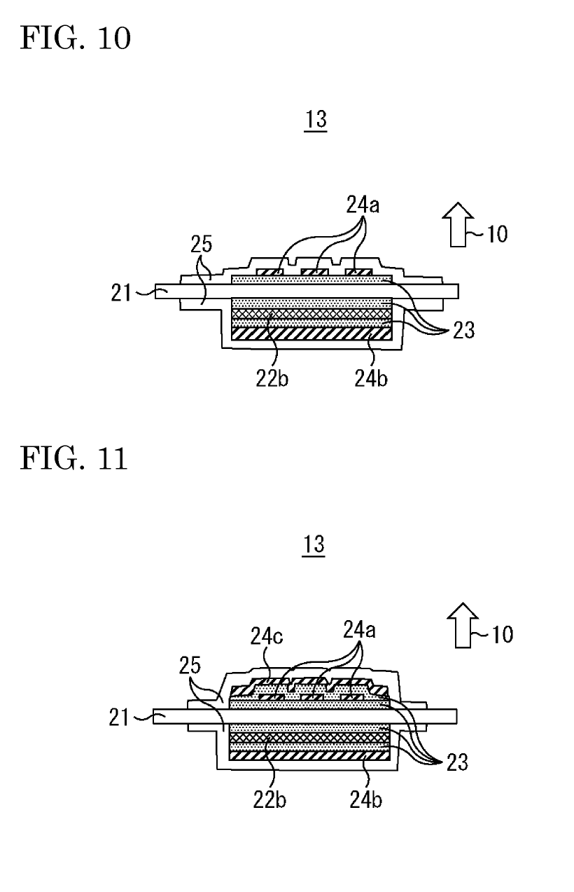

FIG. 10 is a cross sectional view orthogonal to the longitudinal direction of the transmission line section 13 in the flexible board 15 in the present embodiment. In the example shown in FIG. 10, the transmission line section 13 has a so-called coplanar line structure, and a signal layer 24a is formed on the upper surface of a third insulating layer 23 as three interconnections as in FIG. 3.

Moreover, instead of the coplanar line structure as shown in FIG. 10, a tri-plate structure as shown in FIG. 11 may be applied. FIG. 11 is a cross sectional view orthogonal to the longitudinal direction of the transmission line section 13 in the flexible board 15 in the case where the tri-plate structure is applied. In the example shown in FIG. 11, as in the case of the first embodiment, a third insulating layer 23 is formed on the upper side of a signal layer 24a so as to cover the signal layer 24a, and also a guard (shield) layer 24c is formed further on the upper side of the third insulating layer 23.

Further, as in the examples shown in FIG. 5 and FIG. 6, the wireless communication module 11 can also be fabricated in the present embodiment by mounting electronic components on the flexible board 15 with the same procedures as those in the first embodiment.

### Fourth Embodiment

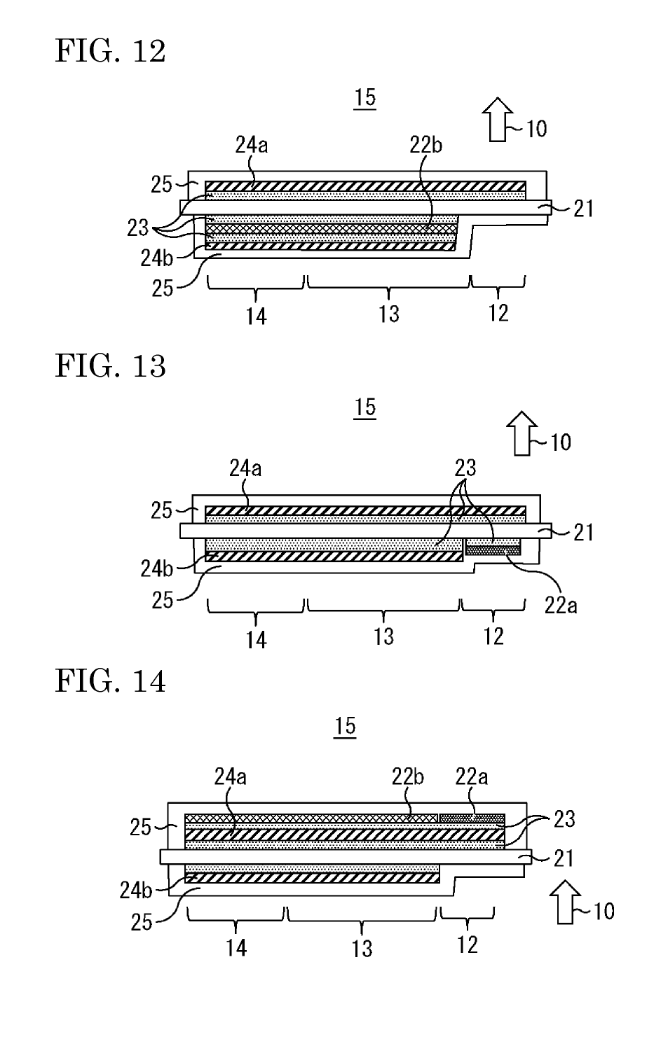

A fourth embodiment of the present invention will be described hereinbelow with reference to FIG. 12 and FIG. 13.

FIG. 12 and FIG. 13 are cross sectional views parallel in the longitudinal direction showing an example of a film-like flexible board 15 in the present embodiment.

As in the third embodiment, the flexible board 15 shown in FIG. 12 also forms a dielectric whose dielectric constants are different between in an area of the transmitting-receiving antenna section 12 and in an area extending from the transmission line section 13 to the high frequency circuit section 14. The flexible board 15 shown in FIG. 12 is different from the structure in the third embodiment shown in FIG. 9 in the point that a third insulating layer 23 that are adhesive layers and a second insulating layer 22a are not formed in the area of the transmitting-receiving antenna section 12 under a first insulating layer 21.

In the example shown in FIG. 12, the structure of the transmission line section 13 and the high frequency circuit section 14 as well as the materials of the conductor layers and the insulating layers are similar to those in the third embodiment. Further, as in the examples shown in FIG. 5 and FIG. 6, the wireless communication module 11 can be fabricated by mounting electronic components on the flexible board 15 shown in FIG. 12 with the same procedures as those in the first embodiment.

Similarly, in the example shown in FIG. 13, a dielectric is formed which includes insulating layers whose dielectric constants are different between in an area of the transmitting-receiving antenna section 12 and in an area extending from the transmission line section 13 to the high frequency circuit section 14. The structure in this embodiment is different from that in the third embodiment shown in FIG. 9 in the point that a second insulating layer 22b is not formed in the area extending from the transmission line section 13 to the high frequency circuit section 14. Therefore, in this area, a ground layer 24b is directly bonded sandwiching a third insulating layer 23 to the lower side of a first insulating layer 21 that is a base film of the flexible board 15.

Also in the example shown in FIG. 13, the structure of the transmission line section 13 and the high frequency circuit section 14 is similar to that of the third embodiment except for the point that a second conductor layer 22b is not formed, and the materials of the conductor layers and the insulating layers are similar to those of the third embodiment. Further, as in the examples shown in FIG. 5 and FIG. 6, the wireless communication module 11 can be fabricated by mounting electronic components on the flexible board 15 shown in FIG. 13 with the same procedures as those in the first embodiment.

### Fifth Embodiment

A fifth embodiment of the present invention will be described hereinbelow with reference to FIG. 14 to FIG. 16.

FIG. 14 is a cross sectional view parallel in the longitudinal direction showing an example of a film-like flexible board 15 in the present embodiment.

In the example shown in FIG. 14, a third insulating layer 23 that is an adhesive layer is formed on the upper side of a first insulating layer 21, and further on the upper side of the third insulating layer 23, a signal layer 24a is seamlessly formed over from an area of the transmitting-receiving antenna section 12 to an area of the transmission line section 13 and the high frequency circuit section 14. Thus, the signal layer 24a that is a conductor layer of the present embodiment is formed seamlessly as a signal interconnection extending from the transmitting-receiving antenna section 12 to the high frequency circuit section 14 through the transmission line section 13.

In the present embodiment, second insulating layers 22a, 22b are further formed on the upper side of the signal layer 24a sandwiching a third insulating layer 23. Also in the present embodiment, dielectrics are formed which have dielectric constants different between in an area of the transmitting-receiving antenna section 12 and in an area extending from the transmission line section 13 to the high frequency circuit section 14. More specifically, the second insulating layer 22a is formed in the area of the transmitting-receiving antenna section 12, while the second insulating layer 22b is formed in the area extending from the transmission line section 13 to the high frequency circuit section 14. The second insulating layers 22a, 22b are made of materials whose dielectric constants are different from each other.

Further on the upper side of the second insulating layers 22a, 22b, a fourth insulating layer 25 is formed seamlessly as a protective layer over from the transmitting-receiving antenna section 12 to the high frequency circuit section 14 through the transmission line section 13 so that the signal layer 24a and the second insulating layers 22a, 22b are covered. In the case where the main purpose of forming the fourth insulating layer 25 is to protect an exposed surface of the conductor layers, the fourth insulating layer 25 may be structured so that the upper side of the second insulating layers 22a, 22b is opened without being covered. The structure of the lower side of the first insulating layer 21 which is constituted from a base film for the flexible board 15 is the same as the structure described with reference to FIG. 2 in the first embodiment.

A description is now given of the aspects in the structure of the transmission line section 13 in the present embodiment different from the structure in the third embodiment shown in FIG. 10 and FIG. 11 with reference to FIG. 15 and FIG. 16.

FIG. 15 is a cross sectional view orthogonal to the longitudinal direction of the transmission line section 13 in the flexible board 15 in the present embodiment. In the example shown in FIG. 15, the transmission line section 13 has a so-called coplanar line structure, and on the upper side of a signal layer 24a forming three interconnections, a third insulating layer 23 is formed so as to cover the signal layer 24a. Further on the upper side of the third insulating layer 23, a second insulating layer 22b is formed to cover the third insulating layer 23. On the upper side of the second insulating layer 22b, a fourth insulating layer 25 as a protective layer is formed so as to cover the second insulating layer 22b.

On the lower side of the first insulating layer where the second insulating layer 22b is not formed, a ground layer 24b having a ground potential is formed sandwiching the third insulating layer 23. On the lower side of the ground layer 24b, a fourth insulating layer 25 as a protective layer is formed so as to cover the third insulating layer 23 and the ground layer 24b.

Instead of the coplanar line structure as shown in FIG. 15, a tri-plate structure as shown in FIG. 16 may be applied. FIG. 16 is a cross sectional view orthogonal to the longitudinal direction of the transmission line section 13 in the case where the tri-plate structure is applied in the present embodiment. In the example shown in FIG. 16, a third insulating layer 23 is formed on the upper side of a second insulating layer 22b, and a guard (shield) layer 24c is formed further on the upper side of the third insulating layer 23. A fourth insulating layer 25 as a protective layer is formed so as to cover the second insulating layer 22b, the third insulating layer 23, and the guard (shield) layer 24c. The rear surface side where the second insulating layer 22b is not formed has the same structure as that in FIG. 15.

Further, as in the examples shown in FIG. 5 and FIG. 6, the wireless communication module 11 can also be fabricated in the present embodiment by mounting electronic components on the flexible board 15 with the same procedures as those in the first embodiment. In this case, not only the fourth insulating layer 25 but also the second insulating layer 22b and the third insulating layer 23 formed under thereof are put into an opened state to expose the signal layer 24a. In the case of the tri-plate structure as shown in FIG. 16, the guard (shield) layer 24c is further opened to expose the signal layer 24a.

### Sixth Embodiment

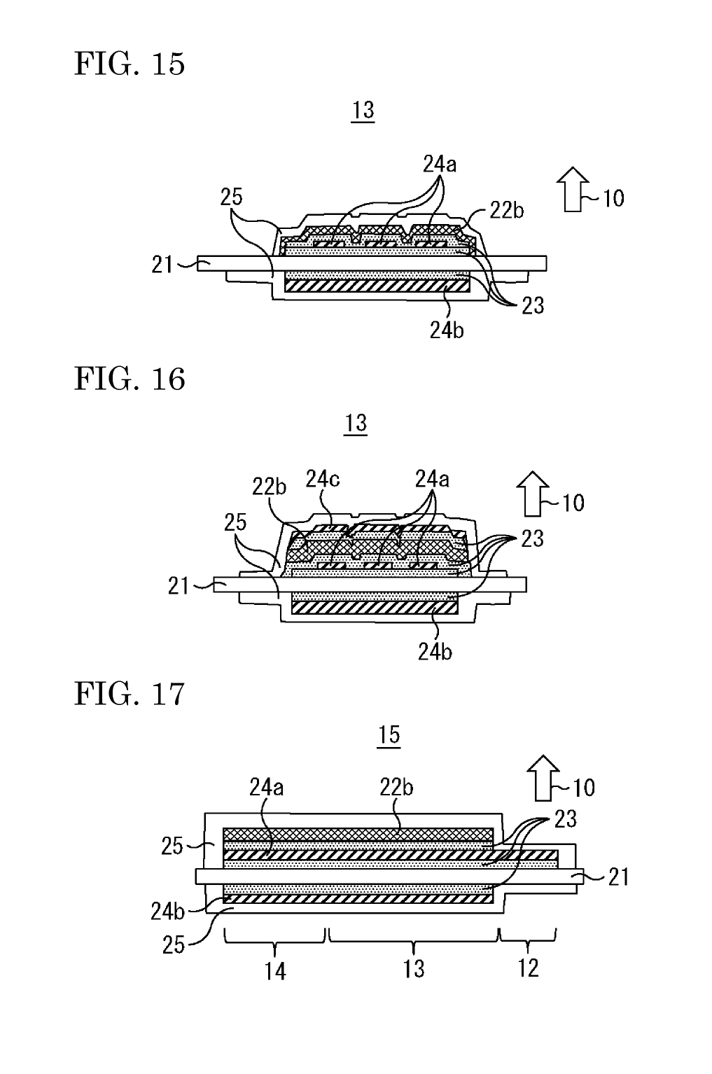

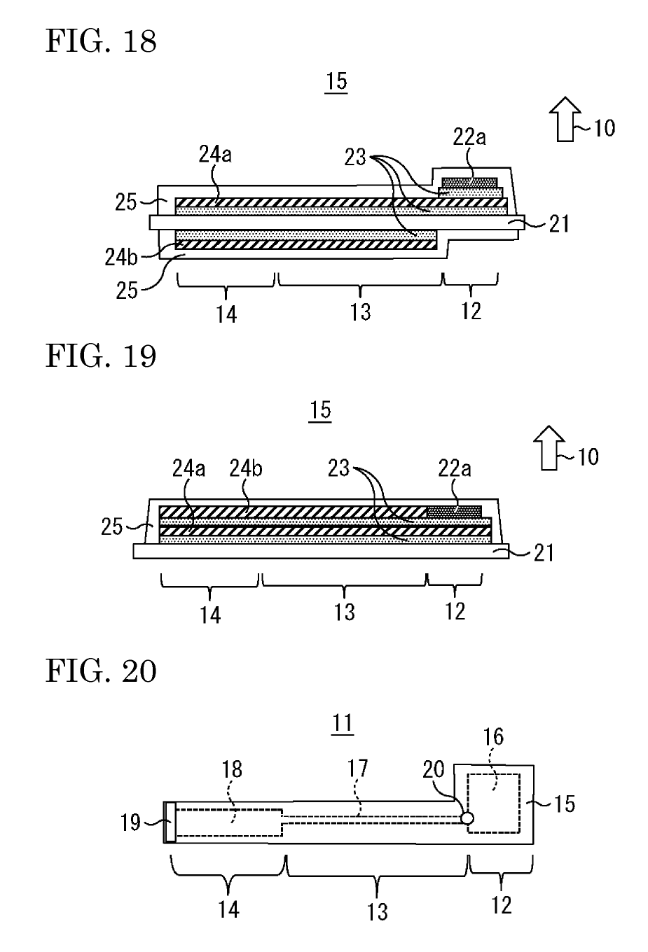

A sixth embodiment of the present invention will be described hereinbelow with reference to FIG. 17 and FIG. 18.

FIG. 17 and FIG. 18 are cross sectional views parallel in the longitudinal direction showing an example of a film-like flexible board 15 in the present embodiment.

As in the fifth embodiment, the flexible board 15 in FIG. 17 also forms a dielectric including insulating layers whose dielectric constants are different between in an area of the transmitting-receiving antenna section 12 and in an area extending from the transmission line section 13 to the high frequency circuit section 14. The flexible board 15 in the present embodiment is different from the structure in the fifth embodiment shown in FIG. 14 in the point that a second insulating layer 22a and a third insulating layer 23 under thereof are not formed in the area of the transmitting-receiving antenna section 12. In the case where the main purpose of forming the fourth insulating layer 25 is to protect an exposed surface of the conductor layers, the fourth insulating layer 25 may be structured so that an upper side of the second insulating layer 22b is opened without being covered.

In the example shown in FIG. 17, the structure of the transmission line section 13 and the high frequency circuit section 14 as well as the materials of the conductor layers and the insulating layers are similar to those in the fifth embodiment. Further, as in the examples shown in FIG. 5 and FIG. 6, the wireless communication module 11 can be fabricated by mounting electronic components on the flexible board 15 shown in FIG. 17 with the same procedures as those in the fifth embodiment.

Also in the example shown in FIG. 18, a dielectric is formed which includes insulating layers whose dielectric constants are different between in an area of the transmitting-receiving antenna section 12 and in an area extending from the transmission line section 13 to the high frequency circuit section 14. The flexible board 15 in FIG. 18 is different from the structure in the fifth embodiment shown in FIG. 14 in the point that a second insulating layer 22b and a third insulating layer 23 under thereof are not formed in the area extending from the transmission line section 13 to the high frequency circuit section 14.

Moreover, in the example shown in FIG. 18, the structure of the transmission line section 13 and the high frequency circuit section 14 as well as the materials of the conductor layers and the insulating layers are similar to those in the example of FIG. 8 described in the second embodiment. Further, as in the examples shown in FIG. 5 and FIG. 6, the wireless communication module 11 can be fabricated by mounting electronic components on the flexible board 15 shown in FIG. 18 with the same procedures as those in the first embodiment.

FIG. 19 is a cross sectional view parallel in the longitudinal direction showing another example of a film-like flexible board 15 in the present embodiment. The flexible board 15 in FIG. 19 is different from the structure shown in FIG. 18 in the point that a ground layer 24b is formed on the upper side of a signal layer 24a sandwiching a third insulating layer 23. In this case, the flexible board 15 is structured to have nothing under a first insulating layer 21. More specifically, the structure shown in FIG. 19 is such that the second insulating layers 22a, 22b, the signal layer 24a, the ground layer 24b, and the fourth insulating layer 25 are all layered on one side of the first insulating layer 21.

Thus, the example shown in FIG. 19 is relatively simple in structure and is also easy to manufacture. Since the flexible board 15 of the present embodiment is structured to have less insulating layers than the flexible boards 15 described in other embodiments, it becomes possible to achieve more downsizing and thinning, and further the flexible board in the present embodiment is more advantageous in manufacturing costs and also its flexibility can be enhanced more.

Further, as in the examples shown in FIG. 5 and FIG. 6, the wireless communication module 11 can be fabricated by mounting electronic components on the flexible board 15 shown in FIG. 19 with the same procedures as those in the first embodiment. In this case, not only the fourth insulating layer 25 but also the ground layer 24b and the third insulating layer 23 formed under thereof are put into an opened state to expose the signal layer 24a.

### Seventh Embodiment

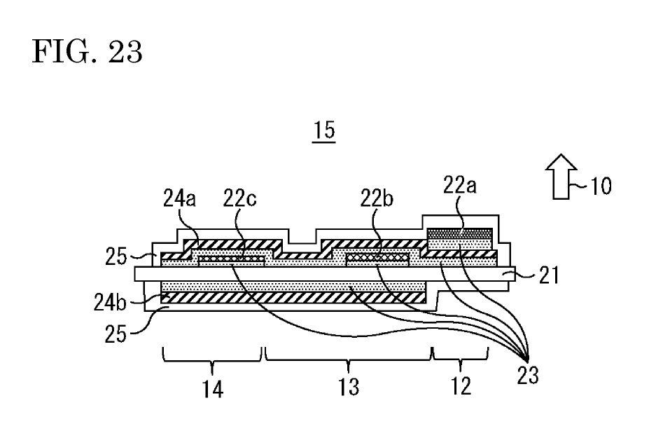

A seventh embodiment of the present invention will be described hereinbelow with reference to FIG. 23.

FIG. 23 is a cross sectional view parallel in the longitudinal direction showing an example of a film-like flexible board 15 in the present embodiment.

The flexible board 15 in FIG. 23 forms a dielectric formed by layering second insulating layers 22a, 22b, 22c, which have dielectric constants different from one another, respectively in an area of the transmitting-receiving antenna section 12, in an area of a part of the transmission line section 13, and in an area of a part of the high frequency circuit sections 14. The flexible board 15 in FIG. 23 is different from the structure in the sixth embodiment shown in FIG. 18 in the point that the second insulating layers 22b, 22c are formed respectively in the area of a part of the transmission line section 13 and in the area of a part of the high frequency circuit section 14. More specifically, the second insulating layers 22b, 22c are formed respectively in between a first insulating layer 21 and a signal layer 24a formed on the upper side of the first insulating layer 21.

The second insulating layer 22a at the area of the transmitting-receiving antenna section 12 is formed at the same position as that of the sixth embodiment shown in FIG. 18. The signal layer 24a that is a conductor layer of the present embodiment is formed seamlessly as a signal interconnection extending from the transmitting-receiving antenna section 12 to the high frequency circuit section 14 through the transmission line section 13.

While relative dielectric constants of the respective second insulating layers 22a, 22b, 22c may arbitrarily be selected depending on design, the relative dielectric constants are made smaller in order of the second insulating layers 22a, 22b, 22c in the example shown in FIG. 23. Since it is important to design the transmitting-receiving antenna section 12 to have a smaller antenna area, the relative dielectric constant of the insulating layer is set higher and the second insulating layer 22a is formed on the upper side of the signal layer 24a which functions as a radiation conductor of electromagnetic waves.

In the transmission line section 13, the second insulating layer 22b is formed on the lower side of the signal layer 24a which is constituted from thin interconnections of the transmission line section 13. Since it is important to suppress dielectric loss and delay of transmission signals in the transmission line section 13, the second insulating layer 22b is made to be an insulating layer with a relative dielectric constant smaller than that of the second insulating layer 22a. Since it is also important to reduce radiation efficiency to the upper space, the second insulating layer 22b is made to be an insulating layer with a relative dielectric constant larger than that of the second insulating layer 22c.

It is to be noted that the second insulating layers 22b, 22c in the present embodiment need not necessarily be formed between the first insulating layer 21 and the signal layer 24a. For example, the second insulating layers 22b, 22c may be formed on the upper side of the signal layer 24a, and the second insulating layers 22b, 22c may also be formed on the lower side of the first insulating layer 21 or on the lower side of the ground layer 24b.

It is desirable that the dielectric constants of the laminated structure, which includes conductor layers and insulating layers in each area of the transmitting-receiving antenna section 12, the transmission line section 13 and the high frequency circuit section 14, can be set in compliance with required specifications. The example shown in FIG. 23 illustrates an example of the specifications where the second insulating layers 22a, 22b, 22c are respectively formed in three areas including the transmitting-receiving antenna section 12, the transmission line section 13 and the high frequency circuit section 14. Therefore, if the dielectric constants can be set in compliance with required specifications, it is not necessary to form the second insulating layers different from one another in all the three areas. For example, the second insulating layers with different dielectric constants may be formed in any one or two areas.

Although the second insulating layer 22a is formed in the entire area of the transmitting-receiving antenna section 12 in the present embodiment, the second insulating layer 22a may be formed in a part of the area of the transmitting-receiving antenna section 12, and a plurality of insulating layers different in dielectric constants may be placed in plane in the area of the transmitting-receiving antenna section 12. For example, when a transmitting-receiving antenna is formed to support two types of frequency, a second insulating layer having a high dielectric constant is formed in an antenna area section supporting low frequency while a second insulating layer having a low dielectric constant is formed in an antenna area section supporting high frequency. In this way, the antenna supporting low frequency can be designed with a priority given to downsizing, whereas the antenna supporting high frequency can be designed with a priority given to radiation efficiency.

Further, as in the examples shown in FIG. 5 and FIG. 6, the wireless communication module 11 can be fabricated by mounting electronic components on the flexible board 15 shown in FIG. 23 with the same procedures as the embodiment disclosed above.

As mentioned above, the flexible board 15 of the present embodiment has insulating layers formed in greater variety than other embodiments while the size thereof is smaller, and transmission loss and radiation loss can be reduced further. So that this makes it possible to provide a wireless communication module which achieves downsizing, thinning and high efficiency.

### Other Embodiments

In each of the aforementioned embodiments, descriptions were made with the conductor layers being divided into the signal layer 24a for transmitting high frequency signals, the ground layer 24b which is a solid pattern having a ground potential, and the guard (shield) layer 24c connected to a stable ground potential or a power supply potential in order to functionally distinguish the conductor layers. It should be understood that the conductor layers are not limited to these, and a plurality of these layers may exist in the present invention.

In the aforementioned first to sixth embodiments, descriptions were given of the examples where the ground layer 24b that is a conductor layer is formed as a seamless conductor layer extending from the transmission line section 13 to the high frequency circuit section 14. The ground layer 24b may be formed instead as a seamless conductor layer extending from the transmitting-receiving antenna section 12 to the high frequency circuit section 14 through the transmission line section 13.

The ground layer 24b and the guard (shield) layer 24c have a function to reduce an influence of electromagnetic waves received from the outside and electromagnetic interference waves emitted to the outside in the area extending from the transmission line section 13 to the high frequency circuit section 14. Therefore, the ground layer 24b and the guard (shield) layer 24c are conductor layers which can be placed in the area extending from the transmission line section 13 to the high frequency circuit section 14, and one of the layers or both the layers can be omitted depending on design.

The third insulating layer 23 that is an adhesive layer is not necessarily needed when insulating layers are bonded together or a conductor layer and an insulating layer are bonded together as seen in publicly known technologies of manufacturing flexible boards.

In the flexible board 15 in each of the aforementioned embodiments, when conductor layers and second insulating layers 22a, 22b are formed on one side or both the sides of the first insulating layer 21 that is a base film by a laminating method, manufacturing technologies of flexible copper laminates or multilayered flexible boards can be used. In the case of forming conductor patterns on conductor layers, a formation method of conductor patterns for flexible printed wiring boards can be used.

The wireless communication module 11 with use of the flexible board 15 in the aforementioned embodiment is made to be even more downsized and thinned and is further made to have flexibility. This makes it possible to mount the wireless communication module 11 according to each of the embodiments on control units such as communication apparatuses, thereby allowing fabrication of highly reliable communication apparatuses.

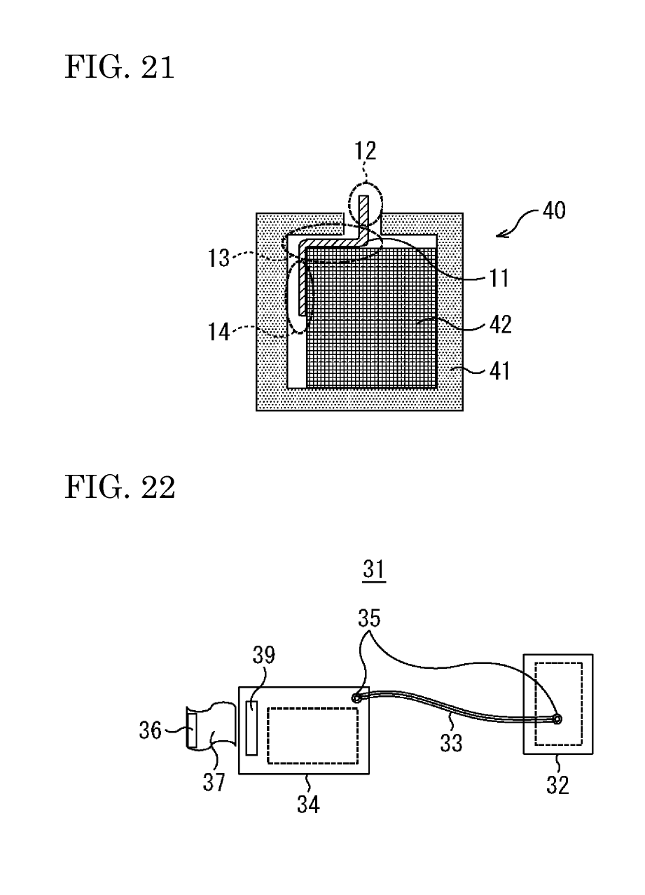

FIG. 21 is a schematic view showing an example of a wireless communication module 11 mounted on a control unit 40.

In the example shown in FIG. 21, the transmitting-receiving antenna section 12 is exposed to the outside from an opening 43 provided in a casing 41 of the control unit to fully exercise a function of enhancing transmitting and receiving efficiency of electric waves and the like. The transmission line section 13 and the high frequency circuit section 14 which are integrally united connected to the transmitting-receiving antenna section 12 are bent at appropriate positions and attached to an internal device 42 of the control unit 40.

As described above, the flexible board 15 in each embodiment has conductor layers seamlessly and integrally united formed from the transmitting-receiving antenna section 12 to the high frequency circuit section 14 through the transmission line section 13. Accordingly, the wireless communication module 11 with use of the flexible board 15, when built into apparatuses such as control units, can easily be fitted in the structure of the control unit.

According to the present invention as disclosed above, it becomes possible to ensure reliability in communication, to achieve downsizing, thinning and flexibility, and to enhance the degree of freedom in design at the time of building into casings of communication apparatuses.

Although the present invention has been described in full detail based on preferable embodiments, it should be understood that the present invention is not limited to these specific embodiments, and various forms which come within the scope and the spirit of the present invention are therefore intended to be embraced therein. It should also be understood that each of the embodiments mentioned above is not restrictive but an illustrative embodiment of the present invention, and respective embodiments may appropriately be combined.

What is claimed is:

1. A flexible printed wiring board, comprising:
a transmitting-receiving antenna section transmitting and receiving a high frequency signal;
a transmission line section transmitting the high frequency signal; and
a high frequency circuit section generating the high frequency signal and feeding the high frequency signal to an electronic component,
the transmitting-receiving antenna section, the transmission line section, and the high frequency circuit section being integrally united formed on an insulation film,
the insulation film having a conductor layer formed on one side or both sides thereof, the conductor layer continuing through the transmitting-receiving antenna section, the transmission line section and the high frequency circuit section,
the insulation film further having insulating layers formed thereon, the insulating layers having dielectric constants different between in an area of the transmitting-receiving antenna section and in an area of the transmission line section and the high frequency circuit section.

2. A flexible printed wiring board, comprising:
a transmitting-receiving antenna section transmitting and receiving a high frequency signal;
a transmission line section transmitting the high frequency signal; and
a high frequency circuit section generating the high frequency signal and feeding the high frequency signal to an electronic component,
the transmitting-receiving antenna section, the transmission line section, and the high frequency circuit section being integrally united formed on an insulation film,
the insulation film having a conductor layer formed on one side or both sides thereof, the conductor layer continuing through the transmitting-receiving antenna section, the transmission line section and the high frequency circuit section,
the insulation film further having an insulating layer formed in at least one area among an area of the transmitting-receiving antenna section, an area of the transmission line section and an area of the high frequency circuit section, the insulating layer having a dielectric constant different from those of other areas.

3. The flexible printed wiring board according to claim 2, wherein
the insulating layer having a dielectric constant different from those of other areas is formed at least in a part of one area among the area of the transmitting-receiving antenna section, the area of the transmission line section and the area of the high frequency circuit section.

4. The flexible printed wiring board according to claim 2, wherein
two antenna regions corresponding to two types of frequency are formed in the transmitting-receiving antenna section, and insulating layers with different dielectric constants are formed in the each antenna regions.

5. The flexible printed wiring board according to claim 1, wherein the insulation film is a base film.

6. The flexible printed wiring board according to claim 1, wherein the insulation film is a polyimide resin film.

7. The flexible printed wiring board according to claim 1, wherein
as the conductor layer, a signal layer and a ground layer are formed facing each other across the insulation film.

8. The flexible printed wiring board according to claim 1, wherein
a signal layer and a guard layer sandwiching an insulating layer covering the signal layer are formed as the conductor layer in the transmission line section and in the high frequency circuit section.

9. The flexible printed wiring board according to claim 1, wherein the insulating layers and the conductor layer are formed on one side of the insulation film.

10. A wireless communication module, comprising:
a flexible printed wiring board; and
an electronic component,
the flexible printed wiring board comprising: a transmitting-receiving antenna section transmitting and receiving a high frequency signal; a transmission line section transmitting the high frequency signal; and a high frequency circuit section generating the high frequency signal and feeding the high frequency signal to an electronic component, the transmitting-receiving antenna section, the transmission line section, and the high frequency circuit section being integrally united formed on an insulation film, the insulation film having a conductor layer formed on one side or both sides thereof, the conductor layer continuing through the transmitting-receiving antenna section, the transmission line section and the high frequency circuit section, the insulation film further having insulating layers formed thereon, the insulating layers having dielectric constants different between in an area of the transmitting-receiving antenna section and in an area of the transmission line section and the high frequency circuit section.
